(19) United States
(12) Patent Application Publication
(10) Pub. No.: US 2024/0188200 A1
(43) Pub. Date: Jun. 6, 2024

(54) COOKING APPLIANCE

(71) Applicant: LG ELECTRONICS INC., Seoul (KR)

(72) Inventors: Seungbok OK, Seoul (KR); Seongjun KIM, Seoul (KR); Seonho JEON, Seoul (KR)

(73) Assignee: LG ELECTRONICS INC., Seoul (KR)

(21) Appl. No.: 18/526,458

(22) Filed: Dec. 1, 2023

(30) Foreign Application Priority Data
Dec. 6, 2022 (KR) 10-2022-0168472

(51) Int. Cl. H05B 6/12; H05B 6/06

(52) U.S. Cl. CPC H05B 6/1263; H05B 6/062; H05B 2213/04

(57) ABSTRACT

A cooking appliance can include an upper plate configured to support an object to be heated; a working coil configured to generate magnetic fields for heating the object; a temperature sensor configured to sense a first temperature of the upper plate; at least one sub temperature sensor configured to sense a second temperature of the upper plate; and a sensor support member including a main mounting portion and a sub mounting portion, the temperature sensor being mounted on the main mounting portion and the at least one sub temperature sensor being mounted on the sub mounting portion. Also, the sensor support member is disposed in a direction extending away from a center of the working coil.

### CROSS-REFERENCE TO RELATED APPLICATIONS

The present application claims priority under 35 U.S.C. 119 to Korean Patent Application No. 10-2022-0168472, filed in the Republic of Korea on Dec. 6, 2022, the entirety of which is hereby incorporated by reference into the present application.

### BACKGROUND

The present disclosure relates to a cooking appliance. More specifically, the present disclosure relates to a cooking appliance that heats food using an induction heating method.

Various types of cooking equipment are used to heat food at home or in a restaurant. Conventionally, gas stoves using gas as fuel have been widely used, but recently devices for heating an object to be heated, for example, cooking vessels such as pots, have been spread using electricity instead of gas.

A method of heating an object to be heated using electricity is largely divided into a resistance heating method and an induction heating method. The electric resistance method is a method of heating an object to be heated by transferring heat generated when an electric current flows through a metal resistance wire or a non-metallic heating element such as silicon carbide to the object to be heated (for example, a cooking vessel) through radiation or conduction. In addition, when high-frequency power of a predetermined amount is applied to the coil, the induction heating method generates an eddy current in the object to be heated consisting of a metal component using a magnetic field generated around the coil to heat the object to be heated itself.

Recently, most of the induction heating methods are applied to cooking appliances.

In the case of such an induction heating-type cooking appliance, magnetic fields are not uniformly distributed, and thus, there can be an area on which the magnetic fields are strongly concentrated and an area on which the magnetic fields are weakly reached on an upper plate on which the object to be heated is disposed. Thus, before the cooking appliance performs a sufficient heating operation, the temperature distribution of the object to be heated can also be non-uniform.

The cooking appliance according to the related art is provided with a temperature sensor at a center of a heating zone for estimating the temperature of the object to be heated. The temperature sensor is being used to estimate the temperature of the object to be heated by sensing the heat transferred from the object to be heated to an upper plate. However, depending on a material of the object to be heated, a type or amount of food, etc., heat can be conducted slowly from the object to be heated to the temperature sensor disposed at a center of the heating zone. In this case, a response speed of the temperature sensor slows down to lead to a secondary limitation in which various functions using the sensed temperature do not operate properly.

Thus, in the related art, a method such as using a separate temperature sensor as an accessory have been proposed. In Korea Patent Publication No. 10-2021-0095491, a second temperature sensor senses a temperature of air flowing in a space between an upper plate and a working coil, but there is still a limitation in reaction speed.

### SUMMARY OF THE DISCLOSURE

Embodiments provide a cooking appliance provided with a temperature sensor and a sub temperature sensor to improve a reaction time.

Embodiments also provide a cooking appliance in which not only a main temperature sensor but also a sub temperature sensor are closely attached to an upper plate to improve a temperature sensing response speed.

A cooking appliance can include the sensor supporter on which the sub temperature sensor is mounted in an outward direction from a center of a working coil to quickly sense a temperature of a heating zone over a large area.

A cooking appliance can include a main temperature sensor and a sub temperature sensor, which are closely attached to a bottom surface of an upper plate to sense a temperature, thereby reducing a reaction time for the temperature sensing.

In one embodiment, a cooking appliance includes: an upper plate on which an object to be heated is disposed; a working coil configured to generate magnetic fields for heating the object to be heated; a temperature sensor configured to sense a temperature of the upper plate; a sub temperature sensor configured to sense a temperature of the upper plate; and a sensor support provided with a main mounting portion, on which the main temperature sensor is mounted, and a sub mounting portion, on which the sub temperature sensor is mounted, in which the sensor support is disposed to be elongated outward from a center of the working coil.

The main mounting portion can be disposed at the center of the working coil, and the sub mounting portion can be disposed above the working coil.

The sub mounting portion can be disposed between the main mounting portion and an outer circumference of the working coil.

The sub temperature sensor can be provided in plurality, and a plurality of sensor spaces, in which the plurality of sub temperature sensors are disposed, can be defined in the sub mounting portion.

Each of the plurality of sensor spaces can have a different spaced distance from the main mounting portion.

The plurality of sensor spaces can be disposed in a straight line.

A harness space, in which a harness connected to the sub temperature sensor is disposed, can be defined in the sub mounting portion.

The harness space can have a bent portion that is bent at least one time.

The bent portion can be bent convexly in a direction of the center of the working coil.

Thermal grease can be filled into the sensor spaces.

The details of one or more embodiments are set forth in the accompanying drawings and the description below. Other features will be apparent from the description and drawings, and from the claims.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a perspective view illustrating a cooking appliance and a cooking container according to an embodiment of the present disclosure.

FIG. 2 is a cross-sectional view illustrating the cooking appliance and the cooking container according to an embodiment of the present disclosure.

FIG. 3 is a circuit diagram of a cooktop according to an embodiment of the present disclosure.

FIG. 4 is a view illustrating output characteristics of the cooktop according to an embodiment of the present disclosure.

FIG. 5 is a view illustrating a current density of a bottom of the cooking container that is being heated by the cooking appliance according to an embodiment of the present disclosure.

FIG. 6 is a control block diagram of the cooking appliance according to an embodiment of the present disclosure.

FIG. 7 is a view illustrating a sensor supporter, on which a main temperature sensor and a sub temperature sensor are mounted, and a working coil of the cooking appliance according to an embodiment of the present disclosure.

FIG. 8 is a cross-sectional view of the sensor supporter and the working coil according to an embodiment of the present disclosure.

FIG. 9 is a view illustrating a space in which a plurality of sub temperature sensors are disposed according to an embodiment of the present disclosure.

FIG. 10 is a view illustrating a state in which the plurality of sub temperature sensors are disposed in the space illustrated in FIG. 9.

### DETAILED DESCRIPTION OF THE EMBODIMENTS

Hereinafter, embodiments relating to the present disclosure will be described in detail with reference to the accompanying drawings. Furthermore, terms, such as a “module” ad a “unit,” are used for convenience of description, and they do not have different meanings or functions in themselves. The features of various embodiments of the present disclosure can be partially or entirely coupled to or combined with each other and can be interlocked and operated in technically various ways, and the embodiments can be carried out independently of or in association with each other.

Hereinafter, a cooking appliance and operating method thereof according to an embodiment of the present disclosure will be described. Hereinafter, “cooking appliance” can mean an induction heating type cooktop, but is not limited thereto.

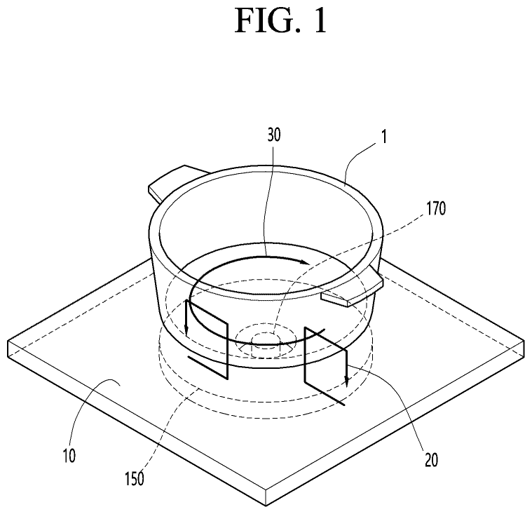

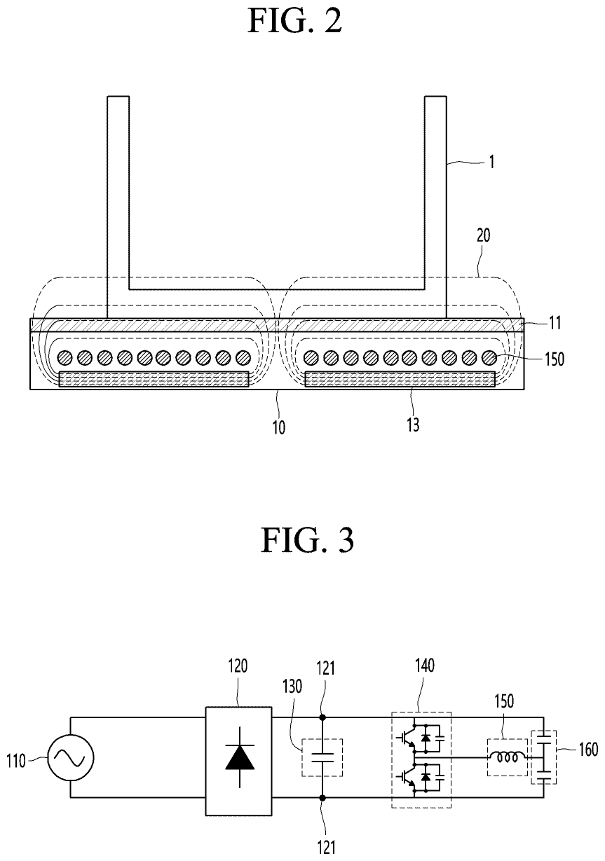

FIG. 1 is a perspective view illustrating a cooking appliance and a cooking container according to an embodiment of the present disclosure, and FIG. 2 is a cross-sectional view illustrating the cooking appliance and the cooking container according to an embodiment of the present disclosure.

A cooking container 1 can be disposed above the cooking appliance 10, and the cooking appliance 10 can heat a cooking container 1 disposed thereon.

First, a method for heating the cooking container 1 using the cooking appliance 10 will be described.

As illustrated in FIG. 1, the cooking appliance 10 can generate a magnetic field 20 so that at least a portion of the magnetic field 20 passes through the cooking container 1. Here, if an electrical resistance component is contained in a material of the cooking container 1, the magnetic field 20 can induce an eddy current 30 in the cooking container 1. Since the eddy current 30 generates heat in the cooking container 1 itself, and the heat is conducted or radiated up to the inside of the cooking container 1, contents of the cooking container 1 can be cooked.

When the material of the cooking container 1 does not contain the electrical resistance component, the eddy current 30 does not occur. Thus, in this case, the cooking appliance 10 may not heat the cooking container 1.

As a result, the cooking container 1 capable of being heated by the cooking appliance 10 can be a stainless steel vessel or a metal vessel such as an enamel or cast iron vessel.

Next, a method for generating the magnetic field 20 by the cooking appliance 10 will be described.

As illustrated in FIG. 2, the cooking appliance 10 can include at least one of an upper plate glass 11, a working coil 12, or a ferrite 13.

The upper plate glass 11 can support the cooking container 1. That is, the cooking container 1 can be placed on a top surface of the upper plate glass 11. A heating area in which the cooking container 1 is heated can be formed on the upper plate 11.

In addition, the upper plate glass 11 can be made of ceramic tempered glass obtained by synthesizing various mineral materials. Thus, the upper plate glass 11 can protect the cooking appliance 10 from an external impact.

In addition, the upper plate glass 11 can prevent foreign substances such as dust from being introduced into the cooking appliance 10.

The working coil 12 can be disposed below the upper plate glass 11. Current may or may not be supplied to the working coil 12 to generate the magnetic field 20. Specifically, the current may or may not flow through the working coil 12 according to on/off of an internal switching element of the cooking appliance 10.

When the current flows through the working coil 12, the magnetic field 20 can be generated, and the magnetic field 20 can generate the eddy current 30 by meeting the electrical resistance component contained in the cooking container 1. The eddy current can heat the cooking container 1, and thus, the contents of the cooking container 1 can be cooked.

In addition, heating power of the cooking appliance 10 can be adjusted according to an amount of current flowing through the working coil 12. As a specific example, as the current flowing through the working coil 12 increases, the magnetic field 20 can be generated more, and thus, since the magnetic field passing through the cooking container 1 increases, the heating power of the cooking appliance 10 can increase.

The ferrite 13 is a component for protecting an internal circuit of the cooking appliance 10. Specifically, the ferrite 13 serves as a shield to block an influence of the magnetic field 20 generated from the working coil 12 or an electromagnetic field generated from the outside on the internal circuit of the cooking appliance 10.

For this, the ferrite 13 can be made of a material having very high permeability. The ferrite 13 serves to induce the magnetic field introduced into the cooking appliance 10 to flow through the ferrite 13 without being radiated. The movement of the magnetic field 20 generated in the working coil 12 by the ferrite 13 can be as illustrated in FIG. 2.

The cooking appliance 10 can further include components other than the upper glass 11, the working coil 12, and the ferrite 13 described above. For example, the cooking appliance 10 can further include an insulator disposed between the upper plate glass 11 and the working coil 12. That is, the cooking appliance according to the present disclosure is not limited to the cooking appliance 10 illustrated in FIG. 2.

FIG. 3 is a circuit diagram of the cooktop according to an embodiment of the present disclosure.

Since the circuit diagram of the cooking appliance 10 illustrated in FIG. 3 is merely illustrative for convenience of description, the embodiment of the present disclosure is not limited thereto.

Referring to FIG. 3, the induction heating type cooktop can include at least some or all of a power supply 110, a rectifier 120, a DC link capacitor 130, an inverter 140, a working coil 150, a resonance capacitor 160, and an SMPS 170.

The power supply 110 can receive external power. Power received from the outside to the power supply 110 can be alternation current (AC) power.

The power supply 110 can supply an AC voltage to the rectifier 120.

The rectifier 120 is an electrical device for converting alternating current into direct current. The rectifier 120 converts the AC voltage supplied through the power supply 110 into a DC voltage. The rectifier 120 can supply the converted voltage to both DC ends 121.

An output terminal of the rectifier 120 can be connected to both the DC ends 121. Each of both the ends 121 of the DC output through the rectifier 120 can be referred to as a DC link. A voltage measured at each of both the DC ends 121 is referred to as a DC link voltage.

A DC link capacitor 130 serves as a buffer between the power supply 110 and the inverter 140. Specifically, the DC link capacitor 130 is used to maintain the DC link voltage converted through the rectifier 120 to supply the DC link voltage to the inverter 140.

The inverter 140 serves to switch the voltage applied to the working coil 150 so that high-frequency current flows through the working coil 150. The inverter 140 drives the switching element constituted by insulated gate bipolar transistors (IGBTs) to allow high-frequency current to flow through the working coil 150, and thus, a high-frequency magnetic field is generated in the working coil 150.

In the working coil 150, current may or may not flow depending on whether the switching element is driven. When current flows through the working coil 150, magnetic fields are generated. The working coil 150 can heat a cooking appliance by generating the magnetic fields as the current flows.

One side of the working coil 150 is connected to a connection point of the switching element of the inverter 140, and the other side is connected to the resonance capacitor 160.

The switching element is driven by a driver, and a high-frequency voltage is applied to the working coil 150 while the switching element operates alternately by controlling a switching time output from the driver. In addition, since a turn on/off time of the switching element applied from the driver is controlled in a manner that is gradually compensated, the voltage supplied to the working coil 150 is converted from a low voltage into a high voltage.

The resonance capacitor 160 can be a component to serve as a buffer. The resonance capacitor 160 controls a saturation voltage increasing rate during the turn-off of the switching element to affect an energy loss during the turn-off time.

The SMPS 170 (switching mode power supply) refers to a power supply that efficiently converts power according to a switching operation. The SMPS 170 converts a DC input voltage into a voltage that is in the form of a square wave and then obtains a controlled DC output voltage through a filter. The SMPS 170 can minimize an unnecessary loss by controlling a flow of the power using a switching processor.

In the case of the cooking appliance 10 expressed by the circuit diagram illustrated in FIG. 3, a resonance frequency is determined by an inductance value of the working coil 150 and a capacitance value of the resonance capacitor 160. Then, a resonance curve can be formed around the determined resonance frequency, and the resonance curve can represent output power of the cooking appliance 10 according to a frequency band.

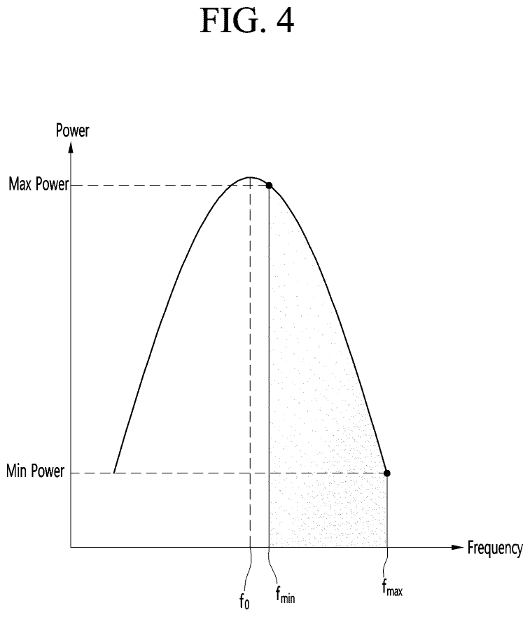

Next, FIG. 4 is a view illustrating output characteristics of the cooktop according to an embodiment of the present disclosure.

First, a Q factor (quality factor) can be a value representing sharpness of resonance in the resonance circuit. Therefore, in the case of the cooking appliance 10, the Q factor is determined by the inductance value of the working coil 150 included in the cooking appliance 10 and the capacitance value of the resonant capacitor 160. The resonance curve can be different depending on the Q factor. Thus, the cooking appliance 10 has different output characteristics according to the inductance value of the working coil 150 and the capacitance value of the resonant capacitor 160.

FIG. 4 illustrates an example of the resonance curve according to the Q factor. In general, the larger the Q factor, the sharper the shape of the curve, and the smaller the Q factor, the broader the shape of the curve.

A horizontal axis of the resonance curve can represent a frequency, and a vertical axis can represent output power. A frequency at which maximum power is output in the resonance curve is referred to as a resonance frequency f0.

In general, the cooking appliance 10 uses a frequency in a right region based on the resonance frequency f0 of the resonance curve. In addition, the cooking appliance 1 can have a minimum operating frequency and a maximum operating frequency, which are set in advance.

For example, the cooking appliance 10 can operate at a frequency corresponding to a range from the maximum operating frequency fmax to the minimum operating frequency fmin. That is, the operating frequency range of the cooking appliance 10 can be from the maximum operating frequency fmax to the minimum operating frequency fmin.

For example, the maximum operating frequency fmax can be an IGBT maximum switching frequency. The IGBT maximum switching frequency can mean a maximum driving frequency in consideration of a resistance voltage and capacity of the IGBT switching element. For example, the maximum operating frequency fmax can be 75 kHz.

The minimum operating frequency fmin can be about 20 kHz. In this case, since the cooking appliance 10 does not operate at an audible frequency (about 16 Hz to 20 kHz), noise of the cooking appliance 10 can be reduced.

Since setting values of the above-described maximum operating frequency fmax and minimum operating frequency fmin are only examples, the embodiment of the present disclosure is not limited thereto.

When receiving a heating command, the cooking appliance 10 can determine an operating frequency according to a heating power level set by the heating command. Specifically, the cooking appliance 10 can adjust the output power by decreasing in operating frequency as the set heating power level is higher and increasing in operating frequency as the set heating power level is lower. That is, when receiving the heating command, the cooking appliance 10 can perform a heating mode in which the cooking appliance operates in one of the operating frequency ranges according to the set heating power.

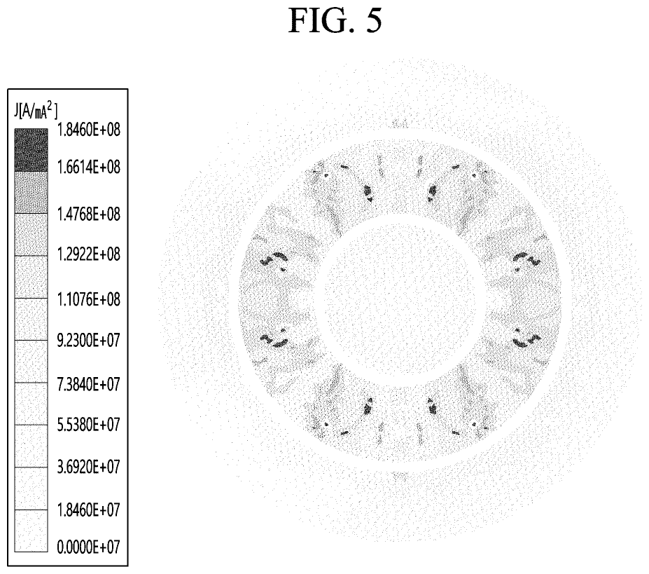

FIG. 5 is a view illustrating a current density of a bottom of the cooking container that is being heated by the cooking appliance according to an embodiment of the present disclosure.

Referring to FIG. 5, it is seen that a current density of a bottom surface of the cooking container 1 is formed non-uniformly. Specifically, it is seen that the current density is low in a center area and an outer circumferential area of the bottom surface of the cooking container 1, while a high current density is formed in an area therebetween, e.g., between the center area and the outer circumferential area.

Thus, when the cooking appliance is provided with only one temperature sensor, it takes a long time for heat to be transferred from another area to the area where the temperature sensor is disposed, which has a disadvantage of deteriorating accuracy of the temperature sensing and slow a response speed.

Thus, the cooking appliance according to an embodiment of the present disclosure is intended to be provided with the plurality of temperature sensors to be able to sense temperatures of various areas of a heating zone on which a current density is formed at various levels.

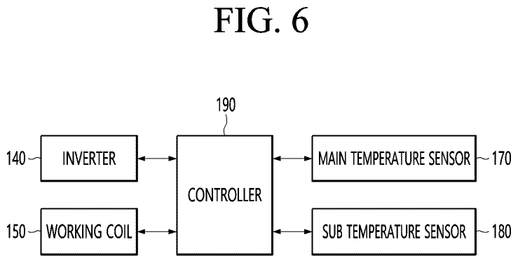

FIG. 6 is a control block diagram of the cooking appliance according to an embodiment of the present disclosure.

The cooking appliance 10 according to an embodiment of the present disclosure can include at least some or all of an inverter 140, a working coil 150, a main temperature sensor 170, a sub temperature sensor 180, and a controller 190.

The inverter 140 can supply current to the working coil 150. The inverter 140 can convert direct current power rectified by a rectifier 120 into alternating current power to supply the converted current power to the working coil 150. The inverter 140 can be provided in various shapes such as a half-bridge or full-bridge.

The working coil 150 can receive current from the inverter 140 to generate magnetic fields that pass through the cooking container 1.

Each of the main temperature sensor 170 and the sub temperature sensor 180 can detect a temperature. The main temperature sensor 170 and the sub temperature sensor 180 can be temperature sensors for directly or indirectly sensing the temperature of the cooking container 1.

The main temperature sensor 170 can be the same as the temperature sensor described in FIG. 1. The main temperature sensor 170 can be disposed at a center of the working coil 150. The main temperature sensor 170 can be disposed to be in direct or indirect contact with the upper plate 11. For example, the main temperature sensor 170 can be disposed to be in contact with a bottom surface of the upper plate 11 to sense the temperature of the upper plate 11.

The main temperature sensor 170 can calculate the temperature of the cooking container 1 through the upper plate 11. Specifically, since the heat of the cooking container 1 is transferred to the upper plate 11, the main temperature sensor 170 can indirectly calculate the temperature of the cooking container 1 by measuring the temperature of the upper plate 11.

Likewise, the sub temperature sensor 180 can calculate the temperature of the cooking container 1 by measuring the temperature of the upper plate 11.

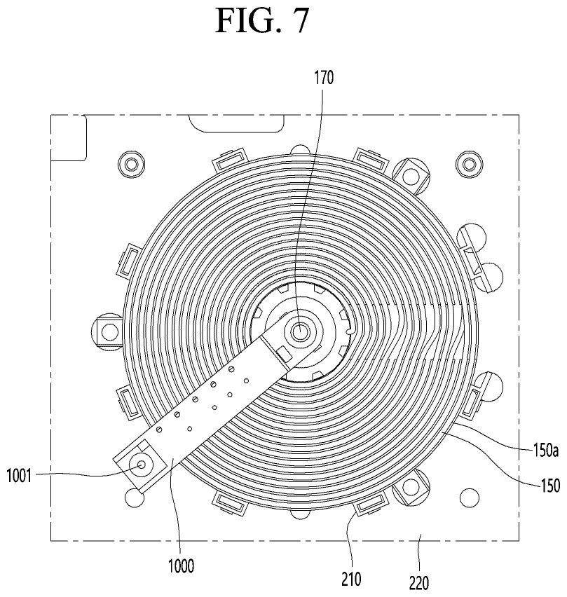

The sub temperature sensor 180 can be disposed on an upper portion of the working coil 150. This will be described in detail with reference to FIGS. 7 to 10.

The controller 190 can control each component provided in the cooktop 10 such as the inverter 140, the working coil 150, the main temperature sensor 170, and the sub temperature sensor 180.

As a specific example, the controller 190 can execute or end various algorithms based on the sensed result of at least one of the main temperature sensor 170 or the sub temperature sensor 180. For example, the controller 180 can execute or end an upper plate overheating prevention algorithm, an artificial intelligence cooking temperature control, a food type/amount estimation algorithm, etc., based on the sensed result of at least one of the main temperature sensor 170 and the sub temperature sensor 180.

To accurately execute the above-described algorithms, accurate temperature sensing can be required. Thus, as described above, the present disclosure can provide the cooking appliance 10 that further includes not only the main temperature sensor 170 but also at least one the sub temperature sensor 180.

The cooking appliance 10 according to an embodiment of the present disclosure can be provided with a sensor supporter 1000 on which the main temperature sensor 170 and the sub temperature sensor 180 are mounted, which will be described in detail below.

FIG. 7 is a view illustrating the sensor supporter, on which the main temperature sensor and the sub temperature sensor are mounted, and the working coil of the cooking appliance according to an embodiment of the present disclosure.

The working coil 150 can be wound around a working coil base 210. The working coil base 210 can guide a position at which the working coil 150 is wound and can fix the wound working coil 150. For this, a plurality of partition walls can be disposed on the working coil base 210. The partition walls can space each turn of the working coil 150 from each other.

The working coil base 210 can be fixed to an aluminum plate 220. For example, the working coil base 210 can be coupled to the aluminum plate 220 through a screw or the like. The aluminum plate 220 can support the working coil base 210.

The sensor supporter 1000 can be supported on at least one of the working coil base 210 or the aluminum plate 220. The sensor supporter 1000 can be fixed to at least one of the working coil base 210 or the aluminum plate 220.

In the present disclosure, the sensor supporter 1000 will be described assuming that the sensor supporter 1000 is fixed to each of the working coil base 210 and the aluminum plate 220. For example, a first fixing portion 1001 and a second fixing portion 1101 can be disposed on the sensor supporter 1000.

Referring to the example of FIG. 7, the first fixing portion 1001 can be a through-hole through which a screw or the like passes. A portion of the sensor supporter 1000 can be fixed to the aluminum plate 220 by the screw passing through the first fixing portion 1001.

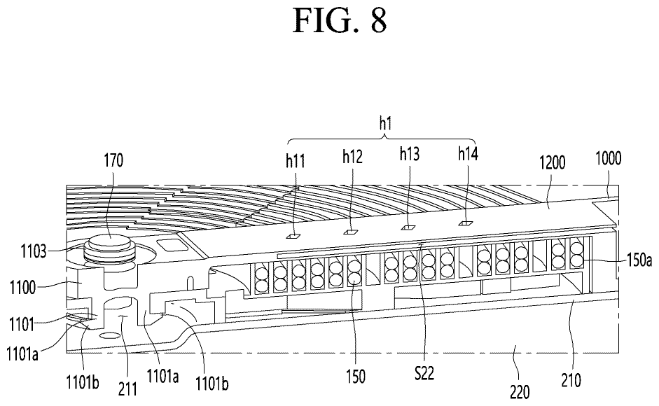

The second fixing portion 1101 will be described with reference to FIG. 8.

FIG. 8 is a cross-sectional view of the sensor supporter and the working coil according to an embodiment of the present disclosure.

A central hole 211 passing in the vertical direction can be defined in a center of the working coil base 210. The central hole 211 can be a passage through which a harness connected to the main temperature sensor 170 passes. In addition, the central hole 211 can be a coupling space into which the second fixing portion 1101 is inserted. For example, the second fixing portion 1101 can be a pair of fitting portions 1101a with a space therebetween, and a protrusion 1101b can be disposed on each of both ends of each pair of fitting portions 110a. The pair of fitting portions 1101a can have elasticity due to the space defined therebetween, and thus, the pair of fitting portions 110a can be fixed by the protrusion 1101b after passing through the central hole 211. That is, the second fixing portion 1101 can be fixed to the working coil base 210 in a manner, in which the second fixing portion 1101 is forcibly inserted into the working coil base 210.

The sensor supporter 1000 can be supported on the working coil base 210 or the aluminum plate 220 by at least one of the first fixing portion 1001 or the second fixing portion 1101, which are described above.

The sensor supporter 1000 can be provided with a main mounting portion 1100 on which the main temperature sensor 170 is mounted and a sub mounting portion 1200 on which the sub temperature sensor 180 is mounted.

The main mounting portion 1100 can be disposed at the center of the working coil base 210. That is, the main mounting portion 1100 can be disposed to overlap the center of the working coil base 210 in the vertical direction. In addition, the main mounting unit 1100 can be disposed at the center of the working coil 150. That is, the main mounting portion 1100 can be disposed to overlap the center of the working coil 150 in the vertical direction. In summary, the main mounting portion 1100, the center of the working coil base 210, and the center of the working coil 150 can be disposed to overlap each other in the vertical direction.

The main mounting portion 1100 can be disposed above the second fixing portion 1101.

The main temperature sensor 170 can be disposed on the main mounting portion 1100, and the main temperature sensor 170 can be fixed by the sensor fixing portion 1103. The sensor fixing portion 1103 can be a circular rubber. The sensor fixing portion 1103 can allow the main temperature sensor 170 to be in close contact with the upper plate 11.

The sub mounting portion 1200 can be disposed between the main mounting portion 1100 and the first fixing portion 1001. The sub mounting portion 1200 can be disposed between the main mounting portion 1100 and an outer perimeter 150a of the working coil 150.

The sub mounting portion 1200 can be disposed above the working coil 150. The sub mounting portion 1200 can be disposed in a direction transverse to the direction in which the working coil 150 is wound. The sub mounting portion 1200 can be disposed in a direction perpendicular to the direction in which the working coil 150 is wound.

The sensor supporter 1000 can be disposed in an outward direction from the center of the working coil 150. In addition, the direction in which the sensor supporter 1000 is directed may not be limited. That is, the sensor supporter 1000 can be disposed in any direction of about 360 degrees, such as about 3 o'clock, about 6 o'clock, or about 12 o'clock, from the center of the working coil 150. For example, the sensor supporter 1000 can have a bridge shape, in which a first end of the sensor supporter 1000 is located at the center of the working coil 150 and a second end of the sensor supporter 1000 is located outside of an outermost coil winding or outermost edge of the working coil 150. Also, an upper surface of the sensor supporter 1000 can be located above the working coil 150 (e.g., the sensor supporter 1000 can extend over the coil windings of the working coil 150). Also, the sensor supporter 1000 can be disposed along a radial direction of the working coil and a length of the sensor supporter 1000 can be greater than a radius of the working coil 150. For example, the sensor supporter 1000 can bridge across the working coil 150 in the radial direction.

An opening hole h1 can be defined in a top surface of the sub mounting portion 1200 to allow the sub temperature sensor 180 to be in contact with the upper plate 11.

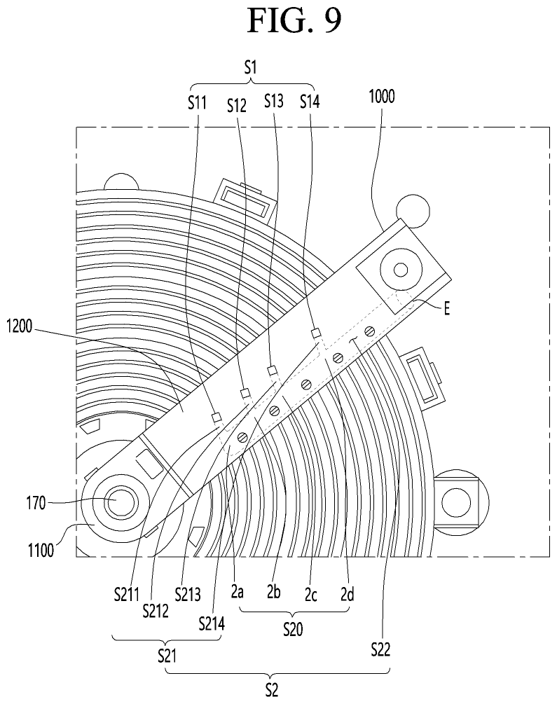

A sensor space S1 (see FIG. 9) in which the sub temperature sensor 180 is disposed and a harness space S2 through which a harness connected to the sub temperature sensor 180 passes can be defined in the sub mounting portion 1200. Here, the sensor space S1 can be in communication with the opening hole h1. Thus, the sub temperature sensor 180 disposed in the sensor space S1 can be in contact with the bottom surface of the upper plate 11 through the opening hole h1. In this respect, the opening hole h1 can be a portion of the sensor space S1.

One or more sub temperature sensors 180 can be provided in the cooking appliance 1. For example, the cooking appliance 1 can include a plurality of sub temperature sensors 180. As the number of sub temperature sensors 180 provided in the cooking appliance 1 increases, temperature estimation accuracy can be improved. In this specification, it is assumed that the cooking appliance 1 is provided with four sub temperature sensors 180, but this is only an example for convenience of explanation. That is, the number of sub temperature sensors 180 provided in the cooking appliance 1 can vary.

The number of opening holes h1 can be one or more. The opening hole h1 can be defined as large one in which all the sub temperature sensors 180 are disposed therein. Alternatively, the opening hole h1 can be defined to correspond to each of the plurality of sub temperature sensors 180. In this specification, it is assumed that the opening hole h1 is defined to correspond to each of the plurality of sub temperature sensors 180.

First to fourth opening holes h11, h12, h13, and h14 corresponding to the first to fourth sub temperature sensors 180, respectively, can be defined in the sub mounting portion 1200. Each of the first to fourth sub temperature sensors 180 can sense a temperature by being in contact with the bottom surface of the upper plate 11 through each of the first to fourth opening holes h11, h12, h13, and h14.

Each of the plurality of sub temperature sensors 180 can be disposed at different distances from the center of the working coil 150. Thus, there is an advantage in that the temperature distribution of the upper plate 11 is more accurately estimated in consideration of a magnetic field concentration area formed according to the spaced distance from the center of the working coil 150.

Like the plurality of sub temperature sensors 180, a plurality of sensor spaces S1 in which the plurality of sub temperature sensors 180 are disposed can be defined in the sub mounting portion 1200.

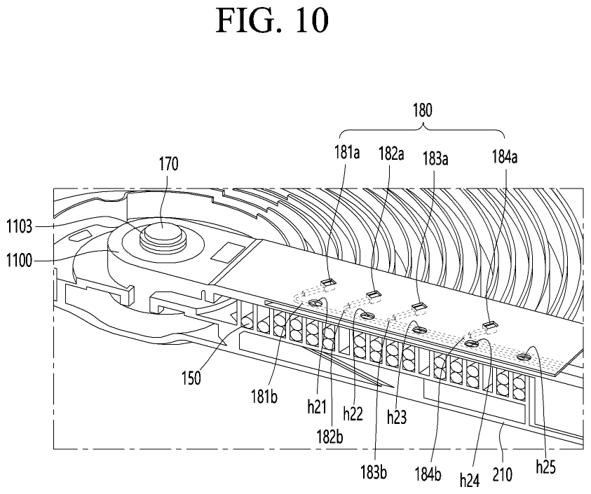

FIG. 9 is a view illustrating a space in which the plurality of sub temperature sensors are disposed according to an embodiment of the present disclosure, and FIG. 10 is a view illustrating a state in which the plurality of sub temperature sensors are disposed in the space illustrated in FIG. 9.

The sub mounting portion 1200 can have first to fourth sensor spaces S11, S12, S13, and S14 in which the first to fourth sub temperature sensors 181a, 182a, 183a, and 184a are disposed, respectively.

That is, the plurality of sensor spaces S1 can include first to fourth sensor spaces S11, S12, S13, and S14. Each of the plurality of sensor spaces S1 can have a different spaced distance from the main mounting unit 1100. That is, each of the plurality of sensor spaces S1 can have a different distance from the center of the working coil 150. For example, the first sensor space S11 can be defined at a first distance from the center of the working coil 150, the second sensor space S12 can be defined at a second distance greater than the first distance from the center of the working coil 150, the third sensor space S13 can be defined at a third distance greater than the second distance from the center of the working coil 150, and the fourth sensor space S14 can be defined at a fourth distance greater than the third distance from the center of the working coil 150. Thus, the first sub temperature sensor 181a can sense a temperature of an area of the upper plate 11 that is the first distance away from the center of the working coil 150, the second sub temperature sensor 182a can sense a temperature of an area of the upper plate 11 that is the second distance away from the center of the working coil 150, the third sub-temperature sensor 183a can sense a temperature of an area of the upper plate 11 that is the third distance away from the center of the working coil 150, and the fourth sub temperature sensor 184a can sense a temperature of an area of the upper plate 11 that is the fourth distance away from the center of the working coil 150.

The plurality of sensor spaces S11, S12, S13, and S14 can be disposed in a straight line. That is, the plurality of sensor spaces S11, S12, S13, and S14 can be disposed in a row.

A harness space S2 can be further defined in the sub mounting portion 1200 in which harnesses 181b, 182b, 183b, and 184b connected to the sub temperature sensor 180 are disposed. The harnesses 181b, 182b, 183b, and 184b can include a first harness 181b connected to the first sub temperature sensor 181a, a second harness 182b connected to the second sub temperature sensor 182a, a third harness 183b connected to the third sub temperature sensor 183a, and a fourth harness 184b connected to the fourth sub temperature sensor 184a.

The harnesses can be disposed inside the sub mounting portion 1200 of the harness space S2. The harness space S2 can be connected to the sensor space S1. The harness space S2 can be a passage through which the harness connected to the sub temperature sensor 180 passes.

The harness space S2 can have a bent portion S20 that is bent at least once. The bent portion S20 can be a structure for fixing the sub temperature sensor 180. Specifically, if the harness space S2 is provided in a straight line, when an external impact such as shaking occurs in the cooking appliance 1, the harness 181b, 182b, 183b, and 184b be shaken together with the sub temperature sensor 180. However, even if the external impact occurs in the cooking appliance 1, the bent portion S20 can minimize a clearance of each of the harnesses 181b, 182b, 183b, and 184b, and the shaking of the sub temperature sensor 180 can also be minimized.

Particularly, the bent portion S20 can be bent toward an opposite side of a harness outlet E. Referring to FIG. 9, the bent portion S20 can be convexly bent toward the center of the working coil 150. The harness outlet E can be a hole defined in the sensor supporter 1000 so that the other end of the harness of which one end is connected to the sub temperature sensor 180, is connected to a PCB, etc., and when the bent portion S20 is bent to an opposite side of the harness outlet E, an effect of fixing the sub temperature sensor 180 can be improved. For example, the bent portion S20 can have a rounded shape or a curved shape that bends away from center of the working coil 150.

The harness space S2 can be constituted by a sensor connection portion S21 and an outlet connection portion S22.

The sensor connection portion S21 can be a space in which the harness connected to each of the sub temperature sensors 180 disposed in the sensor space S1 is disposed, and the outlet connection portion S22 can be a space in which the harness disposed in the sensor connection portion S21 is disposed can be a space defined to extend up to the harness outlet E.

The sensor connection portion S21 and the outlet connection portion S22 can be distinguished by the bent portion S20. The bent portion S20 can have a bent structure for fixing the sub temperature sensor 180 and can be a portion of each of the sensor connection portion S21 and the outlet connection portion S22.

In the present specification, the bent portion S20 will be described assuming that the bent portion S20 is a portion of the outlet connection portion S22. First to fourth bent portions 2a, 2b, 2c, and 2d can be disposed on the outlet connection portion S22, and first to fourth bent portions 2a, 2b, 2c, and 2d can be structures for fixing the first to fourth sub temperature sensors 181a, 182a, 183a, and 184a, respectively.

The first bent portion 2a can be connected to the first sensor connection portion S211, the second bent portion 2b can be connected to the second sensor connection portion S212, and the third bent portion 2c can be connected to the third sensor connection portion S213, and the fourth bent portion 2d can be connected to the fourth sensor connection portion S214.

The sensor connection portion S21 can include a first sensor connection portion S211 connecting the first sensor space S11 to the first bent portion 2a, a second sensor connection portion S212 connecting the second sensor space S12 to the second bent portion 2b, a third sensor connection portion S213 connecting the third sensor space S13 to the third bent portion 2c, and a fourth sensor connection portion S214 connecting the fourth sensor space S14 to the fourth bent portion 2d.

The harnesses 181b, 182b, 183b, and 184b respectively connected to the first to fourth sub temperature sensors 181a, 182a, 183a, and 184a can be gathered to the outlet connection portion S22 via the first to fourth sensor connection portions S211, S212, S213, and S214. The harnesses 181b, 182b, 183b, and 184b gathered to the outlet connection portion S22 can pass through the harness outlet E.

According to an embodiment, at least one discharge hole h21, h22, h23, h24, or h25 can be defined in the top surface of the sub mounting portion 1200. Discharge holes h21, h22, h23, h24, and h25 can be defined above the outlet connection portion S22. The discharge holes h21, h22, h23, h24, and h25 and the outlet connection portion S22 can be connected to each other. The discharge holes h21, h22, h23, h24, and h25 can be holes through which heat generated in the harnesses 181b, 182b, 183b, and 184b is discharged out of the sub mounting portion 1200. Thus, a limitation of damaging the harnesses 181b, 182b, 183b, and 184b due to an increase in temperature of the outlet connection portion S22 can be minimized.

Thermal grease can be filled in the sensor space S1. The thermal grease can be a fluid material that transfers heat. The thermal grease can protect the sub temperature sensor 180 from an external impact, etc. in the sensor space S1. In addition, the thermal grease can transfer the heat of the upper plate 11 to the sub temperature sensor 180 to more improve the sensing speed with respect to the temperature of the bottom surface of the upper plate 11 through the sub temperature sensor 180.

According to the embodiment of the present disclosure, there can be the advantage of being able to quickly sense the temperature of the entire heating zone from the center area of the heating zone to the outer area through the main temperature sensor and sub temperature sensor, which are mounted on the sensor supporter.

According to the embodiment of the present disclosure, the temperature of the entire heating zone can be quickly sensed, which has the advantage of improving the operation accuracy, reliability, and stability of various algorithms according to the temperature.

According to the embodiment of the present disclosure, the plurality of sub temperature sensors can be mounted at the different distances from the center of the working coil to provide the advantage of being able to more accurately recognize the temperature distribution of the heating zone according to the magnetic field distribution.

According to the embodiment of the present disclosure, there can be the advantage in that the stable installation is possible, such as minimizing the clearance of the sub temperature sensor through the design of the harness space.

The above description is merely illustrative of the technical idea of the present disclosure, and various modifications and changes can be made thereto by those skilled in the art without departing from the essential characteristics of the present disclosure.

Therefore, the embodiments of the present disclosure are not intended to limit the technical spirit of the present disclosure but to illustrate the technical idea of the present disclosure, and the technical spirit of the present disclosure is not limited by these embodiments.

The scope of protection of the present disclosure should be interpreted by the appending claims, and all technical ideas within the scope of equivalents should be construed as falling within the scope of the present disclosure.

What is claimed is:

1. A cooking appliance comprising:
an upper plate configured to support an object to be heated;
a working coil configured to generate magnetic fields for heating the object;
a temperature sensor configured to sense a first temperature of the upper plate;
at least one sub temperature sensor configured to sense a second temperature of the upper plate; and
a sensor support member including a main mounting portion and a sub mounting portion, the temperature sensor being mounted on the main mounting portion and the at least one sub temperature sensor being mounted on the sub mounting portion,
wherein the sensor support member is disposed in a direction extending away from a center of the working coil along a radial direction of the working coil.

2. The cooking appliance according to claim 1, wherein the main mounting portion is disposed at the center of the working coil, and
wherein the sub mounting portion is disposed over the working coil.

3. The cooking appliance according to claim 1, wherein the sub mounting portion is disposed between the main mounting portion and an outer circumference of the working coil.

4. The cooking appliance according to claim 1, wherein the at least one sub temperature sensor includes a plurality of sub temperature sensors, and
wherein the sensor support member includes a plurality of sensor spaces defined in the sub mounting portion, the plurality of sub temperature sensors being disposed in the plurality of sensor spaces.

5. The cooking appliance according to claim 4, wherein each of the plurality of sensor spaces is located at a different distance away from the main mounting portion.

6. The cooking appliance according to claim 5, wherein the plurality of sensor spaces are disposed in a straight line.

7. The cooking appliance according to claim 4, further comprising a thermal grease disposed in the plurality of sensor spaces.

8. The cooking appliance according to claim 4, wherein the sensor support member includes a plurality of discharge holes overlapping with wires connected to the plurality of sub temperature sensors.

9. The cooking appliance according to claim 1, wherein a harness space is defined in the sub mounting portion, and
wherein a harness is disposed in the harness space, the harness being connected to the at least one sub temperature sensor.

10. The cooking appliance according to claim 9, wherein the harness space has a bent portion that is bent at least one time.

11. The cooking appliance according to claim 10, wherein the bent portion has a rounded shape or a curved shape that bends away from the center of the working coil.

12. The cooking appliance according to claim 1, wherein the sensor support member has a bridge shape including a first end disposed at center of the working coil and second end disposed outside of an outermost coil winding of the working coil.

13. The cooking appliance according to claim 1, further comprising:
a coil base member, the working coil being wrapped around the coil base member;
a pair of fitting portions protruding from the main mounting portion of the sensor support member; and
a space between the pair of fitting portions,
wherein the pair of fitting portions are inserted into a central hole in the coil base member for fixing the sensor support member on the coil base member.

14. The cooking appliance according to claim 1, wherein the sensor support member includes a harness outlet hole disposed at an end of the sensor support member that is opposite to the center of the working coil.

15. A cooking appliance comprising:
a working coil configured to generate magnetic fields for heating the object;
a temperature sensor configured to sense a first temperature;
at least one sub temperature sensor configured to sense a second temperature; and
a sensor support member supporting the temperature sensor and the at least one sub temperature sensor,
wherein a first end of the sensor support member corresponds to a center of the working coil and a second end of the sensor support member is disposed outside of an outermost coil winding of the working coil, and
wherein the temperature sensor and the at least one sub temperature sensor are located at different distances away from the center of the working coil.

16. The cooking appliance according to claim 15, further comprising an upper plate configured to support the object to be heated,
wherein the sensor support member is disposed between the upper plate and the working coil.

17. The cooking appliance according to claim 15, further comprising a sensor hole in an upper surface of the sensor support member,
wherein the at least one sub temperature sensor is disposed in the sensor hole.

18. The cooking appliance according to claim 15, wherein the temperature sensor is disposed at the center of the working coil.

19. The cooking appliance according to claim 15, further comprising a cavity within the sensor support member,
wherein the at least one sub temperature sensor and a wiring harness connected to the at least one sub temperature sensor are disposed in the cavity.

20. The cooking appliance according to claim 19, wherein the cavity includes a main cavity portion and a sub cavity portion extending from the main cavity portion, and
wherein the sub cavity portion has a shape that bends or curves away from the center of the working coil.
